(19) United States
(12) Patent Application Publication
(10) Pub. No.: US 2010/0110354 A1
(43) Pub. Date: May 6, 2010

(54) TRANSPARENT PRESSURE-SENSITIVE ADHESIVE SHEET AND FLAT PANEL DISPLAY

(75) Inventors: Hidenori Suzuki, Ibaraki-shi (JP); Yasushi Buzoujima, Ibaraki-shi (JP); Tatsuya Suzuki, Ibaraki-shi (JP); Tomohide Banba, Ibaraki-shi (JP); Katsuya Kume, Ibaraki-shi (JP)

Correspondence Address: SUGHRUE MION, PLLC, 2100 PENNSYLVANIA AVENUE, N.W., SUITE 800, WASHINGTON, DC, 20037, US

(73) Assignee: NITTO DENKO CORPORATION, Ibaraki-shi Osaka (JP)

(21) Appl. No.: 12/596,540

(22) PCT Filed: Apr. 18, 2008
(86) PCT No.: PCT/JP2008/057567

§ 371 Date: Oct. 19, 2009

(30) Foreign Application Priority Data
Apr. 20, 2007 (JP) 2007-112194

(51) Int. Cl. G02F 1/1333; B32B 27/00; C08F 230/08

(52) U.S. Cl. 349/122; 428/500; 526/279

(57) ABSTRACT

The present invention provides a transparent adhesive sheet for a flat-panel display, which permits easy re-peeling in early stages, has superior adhesiveness enabling adhesion to a telltale module (telltale panel) and a protective transparent plate with a high adhesive force after adhesion, is superior in adhesion stability particularly at low temperatures, and further has superior punching processability and level difference absorbability.

The above-mentioned object can be achieved by a transparent adhesive sheet containing a polyoxyalkylene polymer as a main component, preferably, a transparent adhesive sheet comprised of a cured product of a composition containing a polyoxyalkylene polymer having at least one alkenyl group in one molecule (Component A), a compound having two or more hydrosilyl groups on average in one molecule (Component B) and a hydrosilylation catalyst (Component C).

### TECHNICAL FIELD

The present invention relates to a transparent adhesive sheet for a flat-panel display. More particularly, the present invention relates to a transparent adhesive sheet for integrating a telltale module and a protective transparent plate by close adhesion and a flat-panel display wherein a telltale module is integrated with a protective transparent plate using the transparent adhesive sheet.

### BACKGROUND ART

Conventionally, flat-panel displays such as a liquid crystal display and the like have a given space between a telltale panel and a protection panel containing a transparent plate (e.g., acrylic plate, glass plate and the like) to protect the telltale panel, so that an impact applied to the display will not reach the telltale panel.

However, since the space is generally an air layer, it causes a problem of unattainable good visibility, which results from a large reflectance loss of light caused by the difference in the refractive index between a material constituting the above-mentioned telltale panel and protection panel, and the air layer.

Thus, for example, a liquid crystal display has been proposed, in which an adhesive comprising a polyorganosiloxane composition having a particular degree of plasticity (silicone adhesive) is filled between a liquid crystal panel and a protection panel to remove the gap (air layer) between them (patent reference 1). For a similar purpose, moreover, a technique for integrating a liquid crystal panel and a transparent board by close adhesion is known, which includes adhering a transparent board for protection to a liquid crystal panel via a transparent adhesive sheet comprising acrylic adhesive (e.g., sheet obtained by processing acrylic acid ester copolymer crosslinked by epoxy, isocyanate, melamine or metal compound crosslinking agent, UV curing acrylic adhesive and the like) (e.g., patent reference 2 etc.).

patent reference 1: JP-A-2004-212521

patent reference 2: JP-A-2002-348546

### DISCLOSURE OF THE INVENTION

### Problems to be Solved by the Invention

As in the above-mentioned patent references 1 and 2, when a protective transparent plate is to be adhered to a flat-panel display (e.g., liquid crystal display and the like) via a transparent adhesive sheet, a telltale module (telltale panel) and the protective transparent plate should be adhered such that no misalignment would occur. However, adhesion failure cannot be completely eliminated and when an adhesion failure occurs, expensive telltale modules (telltale panel) should be discarded since the aforementioned silicone and acrylic transparent adhesive sheets cannot be peeled easily once they are adhered to transparent boards and liquid crystal panels.

Hence, transparent adhesive sheets are required to have easy-to-peel property in early stages that permits re-adhesion even when adhesion failure occurs. On the other hand, in the case of adhesion without failure, adhesion reliability is necessary that ensures adhesion to telltale modules (telltale panel) and protective transparent plates with a sufficiently high adhesion force. However, the aforementioned silicone and acrylic transparent adhesive sheets cannot meet both requirements of easy-to-peel property in early stages and reliability after adhesion.

In addition, a liquid crystal panel mounted on a compact equipment such as cell phone, mobile game machine, car navigation system and the like, which are spreading rapidly in recent years, has a smaller area as compared to that of liquid crystal panel displays such as TV, monitor of personal computers and the like, and naturally, a transparent adhesive sheet to be set between a liquid crystal panel and a protective transparent plate has a smaller area. Considering mass productivity, therefore, such transparent adhesive sheet needs to be cut into a given size by punching processing and the like in the final stages of the production steps. However, punching processing of the aforementioned acrylic transparent adhesive sheet results in poor punching processability as evidenced by a side drop (sag) of adhesive at the cut end portion, delamination of adhesive from a base separator (release sheet) due to the stress on cutting, and the like, and it was found that the acrylic transparent adhesive sheet is unsuitable for mass production of small-sized transparent adhesive sheets.

In addition, mobile equipments such as cell phone, mobile game machine and the like are often used outdoors as well as indoors. In cold areas and mountains, they are often used at a temperature below freezing. It has been found that, under such frigid environments, the aforementioned acrylic transparent adhesive layer (adhesive sheet) cannot maintain high adhesive force to telltale module (telltale panel) of flat-panel displays and protective transparent plates.

In addition, the liquid crystal display of cell phones and mobile game machines often has a black printed layer on the peripheral circumference of a protective transparent plate to provide an easier view, and the surface of such transparent plate provides a different level due to the thickness of the printed layer. Accordingly, when a protective transparent plate having a printed layer is adhered to a telltale module (telltale panel) via a transparent adhesive sheet, unless the transparent adhesive sheet absorbs such level difference, the transparent adhesive sheet develops delamination (air gap) around the end portion of the printed layer, which causes loss of light reflectance to possibly degrade the visibility. Thus, the level difference absorbability of the aforementioned silicone and acrylic transparent adhesive sheets was studied and found to be insufficient.

When, for example, a liquid crystal display of mobile game machines, digital video cameras, car navigation systems, compact music players, compact video reproducers, cell phones and the like is provided, on the liquid crystal module (liquid crystal panel), with what is called a touch panel for operating the equipment by pressing images of the liquid crystal display, a laminate structure for the touch panel, which contains a transparent conductive layer (e.g., ITO (Indium Tin Oxide) layer etc.) between a protective transparent plate and the liquid crystal panel, is formed. Hence, the transparent adhesive sheet is required to have, besides the aforementioned re-peelability, punching processability, low temperature adhesion stability, level difference absorbability and the like, the property (non-corrosiveness of transparent conductive materials) that does not corrode transparent conductive materials such as ITO (Indium Tin Oxide) layer and the like and does not change the conductivity (impedance) of the transparent conductive material layer, even when the sheet is contacted with the transparent conductive material layer.

The present invention has been made in view of the above-mentioned situation and aims to provide a transparent adhesive sheet for a flat-panel display, which is easy to re-peel in the early stages, adheres with a high adhesion force after adhesion to a telltale module (telltale panel) and a protective transparent plate to exhibit superior adhesion stability, and maintains superior adhesion stability even at low temperatures.

Another object is to provide a transparent adhesive sheet for a flat-panel display, which is easy to re-peel in the early stages, adheres with a high adhesion force after adhesion to a telltale module (telltale panel), a protective transparent plate and the like to exhibit superior adhesion stability, and has superior punching processability.

A still another object is to provide a transparent adhesive sheet for a flat-panel display, which is easy to re-peel in the early stages, adheres with a high adhesion force after adhesion to a telltale module (telltale panel), a protective transparent plate and the like to exhibit superior adhesion stability, and has superior level difference absorbability.

A yet another object is to provide a transparent adhesive sheet for a flat-panel display, which is easy to re-peel in the early stages, adheres with a high adhesion force after adhesion to a telltale module (telltale panel) and a protective transparent plate, as well as a functional layer other than a protective transparent plate such as a constituent member of a touch panel and the like to exhibit superior adhesion stability, and is superior in the non-corrosiveness of transparent conductive materials.

A further object is to provide a transparent adhesive sheet for a flat-panel display, which is easy to re-peel in the early stages, adheres with a high adhesion force after adhesion to a telltale module (telltale panel) and a protective transparent plate, as well as a functional layer other than a protective transparent plate such as a constituent member of a touch panel and the like to exhibit superior adhesion stability and is superior in adhesion stability particularly at low temperatures as well as punching processability, level difference absorbability and non-corrosiveness of transparent conductive materials.

In addition, another object is to provide a flat-panel display having a telltale module (telltale panel) and a protective transparent plate, which are integrated by direct close adhesion or via other functional layer formed between them.

### Means of Solving the Problems

The present inventors have conducted intensive studies in an attempt to solve the above-mentioned problems and found that a sheet of a cured product obtained by reacting a polyoxyalkylene polymer with a hydrosilyl group has high transparency, has superior re-peelability in early stages from a telltale module (telltale panel), a protective transparent plate, a transparent electrode layer of a touch panel and the like and adheres thereto with a high adhesion force with the lapse of time after adhesion (preferably promoted by heating), does not become rigid even at extremely low temperatures and maintains its superior adhesiveness even at extremely low temperatures, and that the adhesive sheet is soft and has superior level difference absorbability, superior punching processability and non-corrosiveness of transparent conductive materials that does not corrode transparent conductive materials such as ITO and the like, which resulted in the completion of the present invention.

Accordingly, the present invention provides the following.

(1) A transparent adhesive sheet for a flat-panel display, which comprises a polyoxyalkylene polymer as a main component and is used for adhesion between a telltale module and a protective transparent plate.
(2) The transparent adhesive sheet of the above-mentioned (1), comprising a cured product of a composition comprising the following components A to C:

A: a polyoxyalkylene polymer having at least one alkenyl group in one molecule

B: a compound comprising two or more hydrosilyl groups on average in one molecule

C: a hydrosilylation catalyst

(3) A transparent adhesive sheet for a flat-panel display, which comprises a polyoxyalkylene polymer as a main component, and is used for interlayer adhesion in a multi-layer structure comprising a telltale module, a protective transparent plate, and at least one functional layer other than the protective transparent plate formed between them.
(4) The transparent adhesive sheet of the above-mentioned (3), comprising a cured product of a composition comprising the following components A to C:

A: a polyoxyalkylene polymer having at least one alkenyl group in one molecule

B: a compound comprising two or more hydrosilyl groups on average in one molecule

C: a hydrosilylation catalyst

(5) The transparent adhesive sheet of the above-mentioned (3) or (4), which is placed in at least one of (a) to (c) in the multi-layer structure:
(a) between the protective transparent plate and the functional layer, (b) between two functional layers, and (c) between the functional layer and the telltale module.
(6) The transparent adhesive sheet of the above-mentioned (5), wherein the functional layer is a constituent member of the touch panel.
(7) The transparent adhesive sheet of any of the above-mentioned (1) to (6), which is obtained by laminating a first support (base separator)/an adhesive sheet/a second support (cover separator) in this order, and processing the laminate into a roll.
(8) The transparent adhesive sheet of the above-mentioned (7), wherein the first and the second supports are detachment-treated with a cationic polymerizable UV cured silicone mold release treating agent comprising a cationic polymerization type silicone and an onium salt photoinitiator.
(9) A flat-panel display comprising a telltale module and a protective transparent plate, which are integrated by close adhesion to each other with the transparent adhesive sheet of the above-mentioned (1) or (2) placed between them.
(10) A flat-panel display having a multi-layer structure comprising a telltale module, a protective transparent plate, and at least one functional layer other than the protective transparent plate formed between them, and the transparent adhesive sheet of claim (3) or (4) placed in at least one interlayer in the multi-layer structure.
(11) The flat panel display of the above-mentioned (10), comprising the transparent adhesive sheet of claim (3) or (4) placed in at least one of (a) to (c) in the multi-layer structure:
(a) between the protective transparent plate and the functional layer, (b) between two functional layers, and (c) between the functional layer and the telltale module.
(12) The flat-panel display of the above-mentioned (10), wherein the multi-layer structure comprises a touch panel between the telltale module and the protective transparent plate, and the transparent adhesive sheet of claim (3) or (4) placed between the telltale module and the touch panel, and/or between the touch panel and the protective transparent plate.

### EFFECT OF THE INVENTION

Since the transparent adhesive sheet for a flat-panel display of the present invention has superior re-peelability to a telltale module (telltale panel), a protective transparent plate (e.g., glass plate, acrylic plate etc.) and a constituent member (e.g., transparent electrode layer etc.) of a touch panel and the like, when, for example, an adhesion site is misaligned during an operation to adhere the adhesive sheet to a telltale module (telltale panel) and a protective transparent plate and the adhesion operation needs to be repeated, it is possible to peel off the sheet easily and to repeat the adhesion operation. Therefore, a problem of disposal of an expensive telltale module (telltale panel) due to a mistake in an adhesive sheet adhesion operation does not occur.

In addition, the transparent adhesive sheet of the present invention is soft and markedly improves a peel force with a lapse of time after adhesion to a telltale module (telltale panel), a protective transparent plate (glass plate, acrylic plate etc.) and a constituent member (e.g., transparent electrode layer etc.) of a touch panel and the like. Since the peel force can be particularly improved markedly by heating, the sheet exhibits sufficient adhesion reliability. Using the transparent adhesive sheet of the present invention, therefore, a protective transparent plate can be integrated with a telltale module (telltale panel) by close adhesion without a gap between them, protection with the protective transparent plate can be achieved and a flat-panel display with superior visibility can be realized.

In addition, since the transparent adhesive sheet of the present invention does not become rigid even under a below freezing environment, a flat-panel display with high quality can be obtained, which is free from degradation of the protection effect by a protective transparent plate and visibility even when used under a below freezing environment.

In addition, since the transparent adhesive sheet of the present invention has superior level difference absorbability, when a protective transparent plate has a level difference due to a printed layer, the sheet can absorb the level difference and can prevent development of sheet delamination and air bubbles at the periphery of the printed layer. Hence, even when a protective transparent plate having a printed layer is used, a telltale module (telltale panel) and the protective transparent plate can be integrated by close adhesion without leaving a gap between them.

Moreover, since the transparent adhesive sheet of the present invention has superior punching processability, an adhesive sheet with a small area, which corresponds to a flat-panel display to be mounted on a compact equipment such as a cell phone, a mobile game machine and the like, can be produced with good productivity by a punching processing.

Furthermore, since the transparent adhesive sheet of the present invention has superior non-corrosiveness of transparent conductive materials, when a flat-panel display with a touch panel having a touch panel between a telltale module and a protective transparent plate is to be constituted, the sheet can be directly adhered (bonded) to various functional layers, which are the constituent members of the touch panel, and can also be applied to the adhesion of a protective transparent plate to a flat-panel display with a touch panel.

Moreover, in flat-panel display of the present invention, since a transparent adhesive sheet of the present invention is present between a protective transparent plate and a telltale module, a structure wherein the protective transparent plate is integrated with the telltale module by close adhesion without leaving a gap can be formed, and a flat-panel display superior in the impact resistance and visibility of displayed images can be realized. Also, since an integrated structure of a protective transparent plate and a telltale module is stably maintained even under an extremely low temperature environment, a flat-panel display showing superior impact resistance and visibility of displayed images even under an extremely low temperature environment can be obtained.

### BRIEF DESCRIPTION OF THE DRAWINGS

FIG. 1 is a schematic sectional view of a liquid crystal display wherein a protective transparent plate is integrated with a liquid crystal module by adhesion.

FIG. 2 is a schematic sectional view of a liquid crystal display wherein a touch panel and a protective transparent plate are integrated by close adhesion to a liquid crystal telltale module by the transparent adhesive sheet of the present invention.

FIG. 3 is an explanatory view of a peeling distance test with a constant load.

FIG. 4 is a schematic view of a first test sample used for a low temperature impact test, wherein FIG. 4(a) is first side view and FIG. 4(b) is a second side view.

FIG. 5 is schematic side view of the second test sample used for the low temperature impact test.

FIG. 6 is a perspective view schematically showing an apparatus for low temperature impact test.

FIG. 7 is a side view having a section in a part showing a mounting part of a test sample in a low temperature impact test apparatus.

FIG. 8(a) is an explanatory view of the test operation of a low temperature impact test, and FIG. 8(b) is an explanatory view of a force (inertial force) acting on a test sample.

FIG. 9 is an explanatory view of a resistance change rate measurement test of an ITO layer forming film.

### EXPLANATION OF SYMBOLS

1 transparent adhesive sheet
2 liquid crystal module
3 protective transparent plate
4 touch panel
100, 200 flat-panel display

### BEST MODE FOR CARRYING OUT THE INVENTION

The present invention is explained in the following by referring to preferable embodiments.

The “flat-panel display” in the present invention is a concept including a liquid crystal display (LCD), a plasma display panel (PDP), an organic or inorganic electroluminescent display (ELD), a surface electrolysis display (SED) and the like.

In addition, the “telltale module” means, for example, a panel component containing a display material (hereinafter also to be referred to as a “telltale panel”) mounted with a driver IC for driving and the like, in various flat-panel displays such as a panel component containing a liquid crystal material in a liquid crystal display (LCD) (hereinafter also to be referred to as a “liquid crystal panel”) and the like.

In addition, the “protective transparent plate” includes glass plates, acrylic plates, polycarbonate plates and the like.

The transparent adhesive sheet of the present invention is a sheet comprising polyoxyalkylene polymer as a main component, preferably comprising a cured product obtained by curing a composition containing the following components A to C:

A: a polyoxyalkylene polymer having at least one alkenyl group in one molecule

B: a compound comprising two or more hydrosilyl groups on average in one molecule

C: a hydrosilylation catalyst.

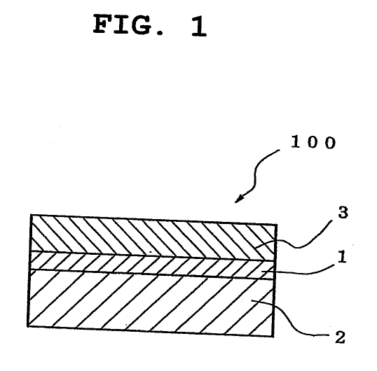

FIG. 1 is a schematic sectional view of a liquid crystal display of a first embodiment of the flat-panel display of the present invention, wherein a protective transparent plate is integrated by close adhesion to a telltale module using the transparent adhesive sheet of the present invention. In the liquid crystal display 100, a transparent adhesive sheet 1 of the present invention is placed between a liquid crystal telltale module 2 and a protective transparent plate 3, and adheres to the liquid crystal telltale module 2 and the protective transparent plate 3, whereby they are adhered to each other and the protective transparent plate 3 is integrated with the liquid crystal telltale module 2 by close adhesion.

The “liquid crystal module” herein is, as mentioned above, a liquid crystal panel containing a liquid crystal material, on which a driver IC for driving and the like is mounted.

The telltale panel in a liquid crystal telltale module is generally a panel component having at least a laminate structure wherein a deflecting plate (polarization filter)/a transparent plate (glass plate, plastic plate)/a liquid crystal material sandwiched between transparent electrodes/a transparent plate (glass plate, plastic plate)/a deflecting plate (polarization filter) are laminated in this order. The transparent adhesive sheet of the present invention shows a high adhesive force to a protective transparent plate, and also a high adhesive force to a deflecting plate (polarization filter) which is an anterior plate of such panel component. Specifically, a deflecting plate (polarization filter) is generally constituted by sandwiching a polyvinyl alcohol film (PVA) stained with iodine with two pieces of triacetylcellulose (TAC), wherein the surface of TAC is not treated, or hard coat treated, anti-glare treated, anti-reflection treated, antistatic treated and the like. The transparent adhesive sheet 1 of the present invention also shows high adhesiveness to these materials. In the liquid crystal display (FIG. 1) of the above-mentioned one embodiment, the transparent adhesive sheet 1 of the present invention is adhered to a deflecting plate (polarization filter).

Incidentally, in flat-panel displays represented by liquid crystal displays, an impact mitigation film (e.g., polyethylene terephthalate film, polyethylene naphthalate film, polycarbonate film, polypropylene film, polyethylene film etc.) which mitigates impact when a protective transparent plate is subjected to impact from the outside, or a shatterproof film (e.g., polyethylene terephthalate film, polyethylene naphthalate film, polycarbonate film, polypropylene film, polyethylene film etc.) for preventing a protective transparent plate from shattering when it is broken may be inserted between a telltale module (telltale panel) and a protective transparent plate. To improve view angle and contrast ratio of display screens, an optical compensation film (e.g., polycarbonate film, cycloolefin resin film, acrylic resin film, the above-mentioned transparent films and those other than the above-mentioned transparent films, to which a liquid crystal material is applied and oriented on the surface, etc.) or glass may be inserted. Furthermore, an attached mechanism such as a touch panel (panel component consisting of a glass plate having a transparent electrode (detection electrode layer)/an adhesive layer/a glass plate having a transparent electrode (driving electrode layer)) and the like may be inserted between a telltale module (telltale panel) and a protective transparent plate.

When such a multi-layer structure wherein one or more functional layers other than a protective transparent plate are formed on the anterior side to be a display surface of a flat-panel display and between a telltale module and a protective transparent plate is formed (hereinafter to be referred to as “anterior multi-layer structure part”) is to be formed, the transparent adhesive sheet of the present invention can also be used for adhesion between layers in the anterior multi-layer structure because it shows superior adhesiveness to various materials regardless of organic or inorganic materials.

More specifically, by inserting the transparent adhesive sheet of the present invention between any layers in the anterior multi-layer structure (e.g., (a) between a protective transparent plate and a functional layer, (b) between two functional layers, (c) between a functional layer and a telltale module etc.), the adhesive sheet becomes coherent to the two layers and adheres them.

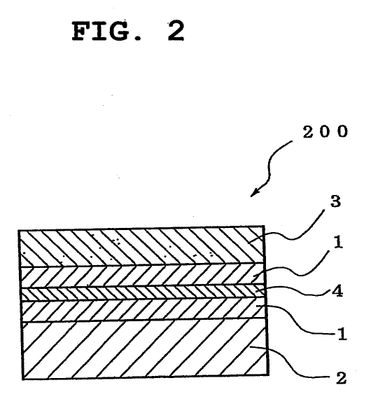

FIG. 2 is a schematic sectional view showing a liquid crystal display of the second embodiment of the flat-panel display of the present invention. The liquid crystal display 200 comprises a touch panel (laminate of glass plate having a transparent electrode (detection electrode layer)/an adhesive layer/a glass plate having a transparent electrode (driving electrode layer)) 4 between a liquid crystal telltale module 2 and a protective transparent plate 3, wherein the transparent adhesive sheet 1 of the present invention is inserted between the liquid crystal telltale module 2 and the touch panel 4, and between the touch panel 4 and the protective transparent plate 3, thereby integrating the touch panel 4 and the protective transparent plate 3 with the liquid crystal telltale module 2 by close adhesion. The transparent adhesive sheet 1 of the present invention can also be used for an adhesive layer to adhere two glass plates with transparent electrode in the touch panel 4. That is, the transparent adhesive sheet 1 of the present invention can also be used for adhesion of a constituent member of the touch panel 4 and the liquid crystal telltale module 2, a constituent member of the touch panel 4 and the protective transparent plate 3, and between constituent members of the touch panel 4.

The transparent adhesive sheet of the present invention can also be applied to not only the above-mentioned liquid crystal display (LCD) but also flat-panel displays other than liquid crystal display (LCD) such as plasma display panel (PDP), organic or inorganic electroluminescent display (ELD), surface-conduction electron-emitter display (SED) and the like. Therefore, using the transparent adhesive sheet of the present invention, a flat-panel display wherein a protective transparent plate is integrated by close adhesion with a telltale module (telltale panel) directly or via a functional layer placed between them can be obtained, whereby a flat-panel display superior in the impact resistance, visibility of displayed images and the like, can be realized.

That is, according to the present invention, a flat-panel display superior in the impact resistance, visibility of displayed images and the like, wherein a telltale module and a protective transparent plate are integrated by close adhesion via a transparent adhesive sheet comprising a polyoxyalkylene polymer as a main component placed between the telltale module and the protective transparent plate, is provided.

Furthermore, a flat-panel display superior in the impact resistance, visibility of displayed images and the like is provided, which has an anterior multi-layer structure having at least one functional layer (other than a protective transparent plate) placed between a telltale module and a protective transparent plate, wherein a transparent adhesive sheet comprising a polyoxyalkylene polymer as a main component is placed in at least one interlayer in the anterior multi-layer structure.

Moreover, a flat-panel display superior in the impact resistance, visibility of displayed images and the like is provided, which has a touch panel between a telltale module and a protective transparent plate, wherein a transparent adhesive sheet comprising a polyoxyalkylene polymer as a main component is placed between the telltale module and the touch panel, and/or between the touch panel and the protective transparent plate.

The transparent adhesive sheet of the present invention is has high transparency, and has a haze value of the sheet as measured by, for example, the below-mentioned test method of preferably not more than 1.2%, more preferably not more than 0.9%. Accordingly, by the presence of the transparent adhesive sheet of the present invention between a protective transparent plate and a telltale module (telltale panel), the visibility of displayed images can be improved.

In the transparent adhesive sheet of the present invention, the “polyoxyalkylene polymer having at least one alkenyl group in one molecule” of component A is not subject to limitation, and various types can be used. In particular, one wherein the main chain of the polymer has a repeat unit represented by the formula (1) shown below is suitable.

The formula (1): —R¹—O—

(wherein R¹ is an alkylene group)

R¹ is preferably a linear or branched alkylene group having 1 to 14, more preferably 2 to 4, carbon atoms.

As specific examples of the repeat unit represented by the formula (1), —CH₂O—, —CH₂CH₂O—, —CH₂CH(CH₃)O—, —CH₂CH(C₂H₅)O—, —CH₂C(CH₃)₂O—, —CH₂CH₂CH₂CH₂O— and the like can be mentioned. The main chain skeleton of the polyoxyalkylene polymer may consist of only one kind of repeat unit, and may consist of two kinds or more of repeat units. Particularly, with regard to availability and workability, a polymer with —CH₂CH(CH₃)O— as the main repeat unit is preferable. In the main chain of the polymer, a repeat unit other than the oxyalkylene group may be contained. In this case, the total sum of oxyalkylene units in the polymer is preferably not less than 80% by weight, particularly preferably not less than 90% by weight.

Although the component A polymer may be a linear polymer or a branched polymer, or a mixture thereof, it is preferable, for obtaining good adhesiveness, that the component A polymer contain a linear polymer at not less than 50% by weight.

The molecular weight of the component A polymer is preferably 500 to 50,000, more preferably 5,000 to 30,000, in terms of number-average molecular weight. If the number-average molecular weight is less than 500, the curing product obtained tends to be too brittle; conversely, if the number-average molecular weight exceeds 50,000, the curing product obtained tends to be so viscous that the workability is considerably reduced; therefore, these cases are undesirable. As mentioned herein, number-average molecular weight refers to a value obtained by the gel permeation chromatography (GPC) method.

The component A polymer preferably has a narrow molecular weight distribution wherein the ratio of weight-average molecular weight and number-average molecular weight (Mw/Mn) is not more than 1.6; a polymer having an Mw/Mn of not more than 1.6 produces a decreased viscosity of the composition and offers improved workability. Hence, the Mw/Mn is more preferably not more than 1.5, still more preferably not more than 1.4. As mentioned herein, Mw/Mn refers to a value obtained by the gel permeation chromatography (GPC) method.

Here, measurements of molecular weight by the GPC method were performed using a GPC apparatus manufactured by Tosoh Corporation (HLC-8120GPC), and weight-average molecular weights were calculated on a polystyrene basis. The measuring conditions are as follows:

Sample concentration: 0.2% by weight (THF solution)

Sample injection volume: 10 μl

Eluent: THF

Flow rate: 0.6 ml/min

Measuring temperature: 40° C.

Column: sample column TSKgel GMH-H(S)

Detector: differential refractometer

With regard to the component A polymer (polyoxyalkylene polymer having at least one alkenyl group in one molecule), the alkenyl group is not subject to limitation, but an alkenyl group represented by the formula (2) shown below is suitable.

General formula (2): H₂C═C(R²)

(wherein R² is hydrogen or a methyl group)

The mode of binding of the alkenyl group to the polyoxyalkylene polymer is not subject to limitation; for example, alkenyl group direct bond, ether bond, ester bond, carbonate bond, urethane bond, urea bond and the like can be mentioned.

As specific examples of the component A polymer, a polymer represented by the formula (3): {H₂C═C(R^{3a})—R^{4a}—O}a₁R^{5a} (wherein R^{3a} is hydrogen or a methyl group; R^{4a} is a divalent hydrocarbon group having 1 to 20 carbon atoms, optionally having one or more ether groups, R^{5a} is a polyoxyalkylene polymer residue; a₁ is a positive integer.) can be mentioned. As R^{4a} in the formula, specifically, —CH₂—, —CH₂CH₂—, —CH₂CH₂CH₂—, —CH₂CH(CH₃) CH₂—, —CH₂CH₂CH₂CH₂—, —CH₂CH₂OCH₂CH₂—, or —CH₂CH₂OCH₂CH₂CH₂— and the like can be mentioned; for the ease of synthesis, —CH₂— is preferable.

A polymer having an ester bond, represented by the formula (4): {H₂C═C(R^{3b})—R^{4b}—OCO}a₂R^{5b}

(wherein R^{3b}, R^{4b}, R^{5b} and a₂ have the same definitions as those of R^{3a}, R^{4a}, R^{5a} and a₁, respectively)
can also be mentioned.

A polymer represented by the formula (5): {H₂C═C(R^{3c})}a₃R^{5c} (wherein R^{3c}, R^{5c} and a₃ have the same definitions as those of of R^{3a}, R^{5a}, and a₁, respectively)

can also be mentioned.

Furthermore, a polymer having a carbonate bond, represented by the formula (6): {H₂C═C(R^{3d})—R^{4d}—O(CO)O}a₄R^{5d} (wherein, R^{3d}, R^{4d}, R^{5d} and a₄ have the same definitions as those of R^{3a}, R^{4a}, R^{5a} and a₁, respectively)

can also be mentioned.

It is preferable that at least 1, preferably 1 to 5, more preferably 1.5 to 3, alkenyl groups be present in one molecule of the component A polymer. If the number of alkenyl groups contained in one molecule of the component A polymer is less than 1, the curing is insufficient; if the number exceeds 5, the mesh structure becomes so dense that the polymer sometimes fails to exhibit a good adherence. The component A polymer can be synthesized according to the method described in JP-A-2003-292926, and any commercially available product can be used as is.

In the present invention, any component B compound comprising two or more hydrosilyl groups on average in one molecule can be used without limitation, as long as it has a hydrosilyl group (a group having an Si—H bond), but from the viewpoint of the ease of obtainment of raw materials and compatibility with the component A, a polyorganohydrogen siloxane modified with an organic constituent is particularly preferable. The polyorganohydrogen siloxane modified with an organic constituent more preferably has an average of 2 to 8 hydrosilyl groups in one molecule. Specific examples of the structure of the polyorganohydrogen siloxane include linear or cyclic ones represented by, for example:

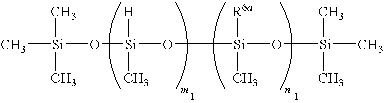

(wherein 2≦m₁+n₁≦50, 2≦m₁, and 0≦n₁. R^{6a} is a hydrocarbon group having 2 to 20 carbon atoms in the main chain thereof, optionally comprising one or more phenyl groups),

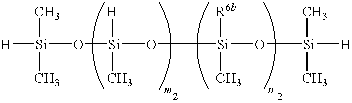

(wherein 0≦m₂+n₂≦50, 0≦m₂, and 0≦n₂. R^{6b} is a hydrocarbon group having 2 to 20 carbon atoms in the main chain thereof, optionally comprising one or more phenyl groups),
or,

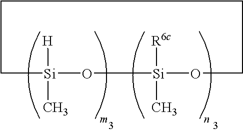

(wherein 3≦m₃+n₃≦20, 2≦m₃≦19, and 0≦n₃<18. R^{6c} is a hydrocarbon group having 2 to 20 carbon atoms in the main chain thereof, optionally having one or more phenyl groups) and the like, and ones having two or more of these units, represented by the following:

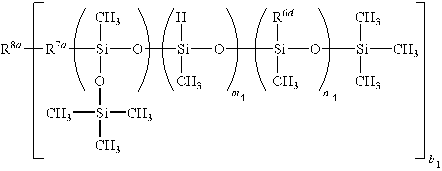

(wherein 1≦m₄+n₄≦50, 1≦m₄, and 0≦n₄. R^{6d} is a hydrocarbon group having 2 to 20 carbon atoms in the main chain thereof, optionally having one or more phenyl groups. 2≦b₁. R^{8a} is a divalent to tetravalent organic group, and R^{7a} is a divalent organic group, but R^{7a} may be absent depending on the structure of R^{8a}),

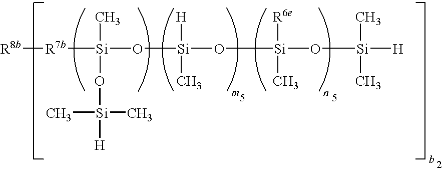

(wherein 0≦m₅+n₅≦50, 0≦m₅, and 0≦n₅. R₆ₑ is a hydrocarbon group having 2 to 20 carbon atoms in the main chain thereof, optionally having one or more phenyl groups. 2≦b₂. R^{8b} is a divalent to tetravalent organic group, and R^{7b} is a divalent organic group. However, R^{7b} may be absent depending on the structure of R^{8b}.), or

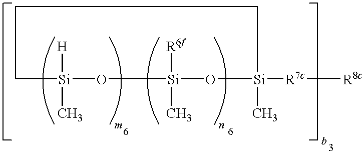

(wherein 3≦m₆+n₆≦50, 1≦m₆, and 0≦n₆. R^{6f} is a hydrocarbon group having 2 to 20 carbon atoms in the main chain thereof, optionally comprising one or more phenyl groups. 2≦b₃. R^{8c} is a divalent to tetravalent organic group, and R^{7c} is a divalent organic group. However, R^{7c} may be absent depending on the structure of R^{8c}.) and the like.

The component B preferably has good compatibility with the component A and the component C, or good dispersion stability in the system. Particularly, if the viscosity of the entire system is low, use of an ingredient whose compatibility with any of the above-described ingredients is low as the component B sometimes causes phase separation and a curing failure.

As a specific example of the component B having relatively good compatibility with the component A and the component C, or relatively good dispersion stability, the following can be mentioned.

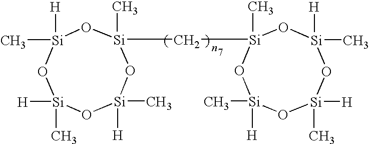

(wherein n₇ is an integer of not less than 4 and not more than 10,)

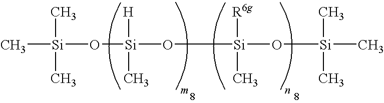

(wherein 2≦m₈≦10 and 0≦n₈≦5, R^{6g} is a hydrocarbon group having eight or more carbon atoms.)

As specific preferable examples of the component B, polymethylhydrogen siloxane can be mentioned; for assuring compatibility with the component A and adjusting the SiH content, a compound modified with α-olefin, styrene, α-methylstyrene, allylalkyl ether, allylalkyl ester, allylphenyl ether, allylphenyl ester or the like can be mentioned; as an example, the following structure can be mentioned.

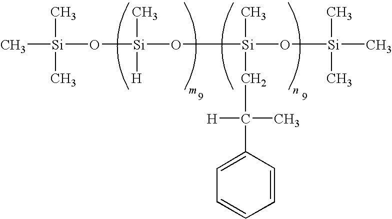

(wherein 2≦m₉≦20 and 1≦n₉≦20.)

The component B can be synthesized by a commonly known method, and any commercially available product can be used as is.

In the present invention, the component C hydrosilylation catalyst is not subject to limitation; an optionally chosen one can be used. As specific examples, chloroplatinic acid; simple substance platinum; solid platinum carried by a carrier such as alumina, silica, or carbon black; a platinum-vinylsiloxane complex {for example, Ptₙ(ViMe₂SiOSiMe₂Vi)ₘ, Pt[(MeViSiO)₄]ₘ and the like}; a platinum-phosphine complex {for example, Pt(PPh₃)₄, Pt(PBu₃)₄ and the like}; a platinum-phosphite complex {for example, Pt[P(OPh)₃]₄, Pt[P(OBu)₃]₄ and the like}; Pt(acac)₂; the platinum-hydrocarbon conjugates described in U.S. Pat. Nos. 3,159,601 and 3,159,662 of Ashby et al.; the platinum alcoholate catalyst described in U.S. Pat. No. 3,220,972 of Lamoreaux et al. and the like can be mentioned. (In the formulas above, Me represents a methyl group, Bu represents a butyl group, Vi represents a vinyl group, Ph represents a phenyl group, acac represents an acetylacetonate, and each of n and m represents an integer.)

As examples of catalysts other than platinum compounds, RhCl(PPh₃)₃, RhCl₃, Rh/A₂O₃, RuCl₃, IrCl₃, FeCl₃, AlCl₃, PdCl₂. 2H₂O, NiCl₂, TiCl₄ and the like can be mentioned. These catalysts may be used alone, and may be used in combination of 2 kinds or more. With regard to catalyst activity, chloroplatinic acid, a platinum-phosphine complex, a platinum-vinylsiloxane complex, Pt(acac)₂ and the like are preferable.

Although the amount of the component C formulated is not subject to limitation, from the viewpoint of assurance of composition potlife and sheet transparency, the amount is generally not more than 1×10⁻¹ mol, preferably not more than 5.3×10⁻² mol, relative to 1 mol of alkenyl groups in the component A; particularly, from the viewpoint of sheet transparency, the amount is more preferably not more than 3.5×10⁻² mol, particularly preferably not more than 1.4×10⁻³ mol. If the amount exceeds 1×10⁻¹ mol relative to 1 mol of alkenyl groups in the component A, the finished impact absorption sheet is likely to undergo yellowing and the transparency of the sheet tends to be damaged. If the amount of the component C formulated is too low, the composition curing speed is slow, and the curing quality tends to be unstable; therefore, the amount is preferably not less than 8.9×10⁻⁵ mol, more preferably not less than 1.8×10⁻⁴ mol.

A composition comprising the above-described components A to C is characterized by the ability to exhibit its tacky characteristic (function to adhere to another object) even without the addition, or with the addition of a small amount, of an adhesiveness-imparting resin.

In the composition, component A and component B are preferably mixed such that the functional group ratio of the hydrosilyl group of component B (compound B) to the alkenyl group of component A (compound A) will be not less than 0.3 and less than 2, more preferably within the range of not less than 0.4 and less than 1.8, further more preferably within the range of not less than 0.5 and less than 1.5. When the hydrosilyl groups are contained so that the foregoing functional group ratio will exceed 2, the crosslinking density increases, and it is sometimes impossible to obtain adhesiveness without the addition, or with the addition of a small amount, of an adhesiveness-imparting resin. When the functional group ratio is less than 0.3, the crosslinking becomes too weak, and adhesive deposit upon re-peeling and degraded characteristic retention at high temperatures may occur. Hence, by setting a blending ratio of the component A and the component B to fall within a particular range, good adhesiveness can be achieved even without adding an adhesiveness-imparting resin, and, in addition, the composition can be cured at a practically sufficiently fast line speed.

Such composition may contain a storage stability improving agent for the purpose of improving the storage stability. As this storage stability improving agent, a commonly known compound known as a storage stabilizer for the component B of the present invention can be used without limitation. For example, a compound comprising an aliphatic unsaturated bond, an organic phosphorus compound, an organic sulfur compound, a nitrogen-containing compound, a tin compound, an organic peroxide and the like can be suitably used. Specifically, 2-benzothiazolyl sulfide, benzothiazole, thiazole, dimethylacetylene dicarboxylate, diethylacetylene dicarboxylate, 2,6-di-t-butyl-4-methylphenol, butylhydroxyanisole, vitamin E, 2-(4-morpholinyldithio)benzothiazole, 3-methyl-1-butene-3-ol, 2-methyl-3-butene-2-ol, organosiloxane containing an acetylenic unsaturated group, acetylene alcohol, 3-methyl-1-butyl-3-ol, diallyl fumarate, diallyl maleate, diethyl fumarate, diethyl maleate, dimethyl maleate, 2-pentenenitrile, 2,3-dichloropropene and the like can be mentioned, but these are not to be construed as limitative.

Where necessary, moreover, an adhesion-imparting agent may be added to improve adhesiveness to the liquid crystal panel and/or protective transparent plate. As examples of the adhesion provider, various silane coupling agents, epoxy resins and the like can be mentioned. In particular, a silane coupling agent having a functional group such as an epoxy group, a methacryloyl group, or a vinyl group is preferable because its influence on the curing quality is small and also because it is highly effective for the development of adhesiveness. In combination with a silane coupling agent and an epoxy resin, a catalyst for reacting silyl groups or epoxy groups can be added. When using them, their influence on the hydrosilylation reaction must be taken into consideration. Various filling agents, antioxidants, ultraviolet absorbents, pigments, surfactants, solvents, and silicon compounds may be added to the composition as appropriate. As specific examples of the above-described filling agents, silica micropowder, calcium carbonate, clay, talc, titanium oxide, zinc oxide, diatomaceous earth, barium sulfate and the like can be mentioned. Of these filling agents, silica micropowder, particularly micropowder silica having a particle diameter of about 50 to 70 nm (the BET specific surface area is 50 to 380 m²/g) is preferable; in particular, surface-treated hydrophobic silica is particularly preferable because of its high function to improve the strength in the preferred direction. Furthermore, a tackifier resin may be added to the composition as required to enhance the tack and other characteristics thereof; as examples of the tackifier resin, terpene resin, terpene phenol resin, petroleum resin, rosin ester and the like can be mentioned, one of which can be freely selected according to the intended use.

For the characteristic improvements, resins such as phenol resin, acrylic resin, styrene resin, and xylene resin can be added. An adhesive ingredient such as an acrylic adhesive, a styrene block adhesive, or an olefin adhesive can be added for the same purpose.

The transparent adhesive sheet of the present invention has superior re-peeling property, and can be relatively easily peeled off after adhesion to a telltale panel such as a liquid crystal panel and the like and a protective transparent plate in flat-panel displays. That is, the transparent adhesive sheet of the present invention shows an early stage peel force from glass of not more than 10 N/25 mm, preferably not more than 8 N/25 mm as measured by the below-mentioned test method. In addition, it shows an early stage peel force from deflecting plate of not more than 10 N/25 mm, preferably not more than 8 N/25 mm as measured by the below-mentioned test method. Accordingly, for example, in an operation to adhere a liquid crystal panel to a protective transparent plate via a transparent adhesive sheet, when the adhesion position of the liquid crystal panel and/or protective transparent plate is misaligned from a predetermined position, the transparent adhesive sheet can be peeled off to reattempt adhesion. Therefore, a problem of the need to discard the expensive liquid crystal panel does not occur.

On the other hand, the transparent adhesive sheet of the present invention shows an increasing peel force with time. Particularly, the peel force markedly increases by heating to show sufficient adhesion reliability. That is, the transparent adhesive sheet of the present invention shows good adhesion reliability to glass as evidenced by an 80° C.-accelerated peel force from glass after being left under an 80° C. environment for 70 hr of not less than 10 N/25 mm, preferably not less than 11 N/25 mm, as measured by the below-mentioned test method. In addition, it shows good adhesion reliability to a deflecting plate as evidenced by an 80° C.-accelerated peel force from deflecting plate after being left under an 80° C. environment for 70 hr of not less than 10 N/25 mm, preferably not less than 11 N/25 mm, as measured by the below-mentioned test method. Accordingly, for example, in an operation to adhere a liquid crystal panel to a protective transparent plate via a transparent adhesive sheet, when the adhesion position is misaligned from a predetermined position, the transparent adhesive sheet can be peeled off to reattempt adhesion. On the other hand, when the adhesive sheet is accurately adhered, it shows adhesion reliability suitable for practical use, since the adhesion force increases with time.

In addition, the transparent adhesive sheet of the present invention is particularly superior in the adhesion stability at low temperatures, and can maintain a high adhesion force to a telltale panel and a protective transparent plate even at a below freezing temperature. Specifically, the transparent adhesive sheet of the present invention shows a shear storage elastic modulus (G′) of not more than 6.0×10⁵ (Pa), preferably not more than 5.5×10⁵ (Pa), at −30° C. While the shear storage elastic modulus (G′) is known as an index of the hardness of a viscoelastic body, since the shear storage elastic modulus (G′) of the transparent adhesive sheet of the present invention is not more than 6.0×10⁵ (Pa) at −30° C. and does not become rigid at a low temperature, it is considered to maintain a high adhesive force even at a freezing temperature. In consideration of the temperature-time conversion law, moreover, high-speed deformation at a certain temperature is influenced by the property of a viscoelastic body at a lower temperature. Therefore, the adhesion stability at −30° C. can only be discussed in consideration of the viscoelastic behavior at a lower temperature. The shear storage elastic modulus of the transparent adhesive sheet of the present invention is not more than 6.0×10⁵ (Pa) at −50° C. Therefore, the sheet is considered to have extremely superior adhesion stability at a low temperature.

As is clear from the below-mentioned Comparative Examples 1-3, an acrylic transparent adhesive sheet and a silicone transparent adhesive sheet have a shear storage elastic modulus (G′) at −30° C. of 6.8×10⁵ (Pa) for the lowest (Comparative Example 2) and a shear storage elastic modulus (G′) at −50° C. of 1.4×10⁷ (Pa) for the lowest (Comparative Example 3). It is appreciated that the transparent adhesive sheet of the present invention has extremely good adhesion stability (adhesive force sustainability) at low temperatures.

Furthermore, for example, when, in liquid crystal displays (LCD) of mobile game machines, digital video cameras, car navigation systems, compact music players, compact video players, cell phones and the like, what is called a touch panel mechanism permitting operation of equipment by pressing what is displayed on the liquid crystal image screen at the anterior of the liquid crystal panel is to be set, the transparent adhesive sheet of the present invention is adhered to a glass or plastic film with a transparent electrode layer formed thereon. In this case, since the transparent adhesive sheet of the present invention has superior non-corrosiveness of transparent conductive materials (particularly ITO non-corrosiveness), which does not cause corrosion of transparent conductive materials such as ITO, TO (tin oxide), ZnO (zinc oxide), CTO (cadmium tin oxide) and the like, even when the sheet is contacted with the transparent conductive materials, the sheet acts advantageously when a touch panel is present between a protective transparent plate and a telltale module.

In addition, the transparent adhesive sheet of the present invention has superior level difference absorbability, as can be seen from the below-mentioned Experimental Example. Accordingly, for example, even when a printed layer in a deep color such as black and the like is formed along the periphery of protective transparent plate (printed layer with generally about 0.1-20 μm thickness), the level difference at the end portion of said printed layer can be sufficiently absorbed, and a problem of delamination (gap) of the transparent adhesive sheet at the end portion of the printed layer does not occur.

While the thickness of the transparent adhesive sheet of the present invention varies depending on the kinds of a display device (flat-panel display), it is generally not more than 1000 μm, preferably not more than 500 μm, to provide a thin display device (flat-panel display). However, when the sheet is too thin, the level difference absorbability at the printed part, which is formed on the protection panel, becomes unfavorable. Thus, the lower limit of the thickness is preferably not less than 10 μm, more preferably 15-300 μm, particularly preferably 25-250 μm.

The transparent adhesive sheet of the present invention can be basically prepared without a solvent, and characteristically contains a small amount of a low molecular weight and highly volatile oligomer component. Therefore, even when it is used for equipment mounted with a flat-panel display, which is increasingly used daily in recent years, an adverse influence on the human body is advantageously small.

The transparent adhesive sheet of the present invention is produced, for example, by the following method.

A composition containing a polyoxyalkylene polymer as a main component (composition containing the above-mentioned components A-C) is charged in a stirrer equipped with a vacuum function together with an organic solvent as necessary. The mixture is defoamed by stirring under reduced pressure (in vacuo). The fluid product after said vacuum defoaming is applied (cast) to various supports, and treated with heat to form a sheet. The composition is heat-cured by a heat treatment to give a sheet of the cured product. Coating on the support can be performed using, for example, a commonly known coating apparatus such as a gravure coater; a roll coater such as a kiss coater or a comma coater; a die coater such as a slot coater or a fountain coater; a squeeze coater, a curtain coater and the like. Preferable heat treatment conditions during the coating are 50-200° C. (preferably 100-160° C.) for about 0.01-24 hr (preferably 0.05-4 hr). As the above-described stirrer with vacuum function, a commonly known stirrer equipped with vacuum apparatus may be used; specifically, a planetary (revolution type/rotation type) stirring defoaming apparatus, a defoaming apparatus equipped with a disperser, and the like can be mentioned. The degree of pressure reduction in performing vacuum defoaming is preferably not more than 10 kPa, more preferably not more than 3 kPa. Stirring time varies also depending on the choice of stirrer and the throughput of fluidized product, and is generally preferably about 0.5 to 2 hours. By the defoaming treatment, bubbles (voids) substantially do not exist in the sheet, and the sheet shows superior optical property (transparency). For example, the Haze value of a sheet measured by the below-mentioned test method is preferably not more than 1.2%, more preferably not more than 0.9%.

Particularly, when the transparent adhesive sheet of the present invention is used to adhere a telltale panel of a flat-panel display to a protective transparent plate, which are to be mounted on compact equipments such as cell phones, mobile game machines, car navigation systems and the like, the sheet needs to be processed into a sheet with a small area size. However, for mass production (production efficiency), for example, it is preferable to produce a roll consisting of a laminate structure of a first support (base separator)/cured product layer of composition containing the above-mentioned components A to C (transparent adhesive sheet)/second support (cover separator), and produce sheets by a punching process while developing the roll.

The above-mentioned roll can be prepared by, for example, a mold release treatment by applying a mold release treatment agent to a first support, stirring and vacuum defoaming the composition containing the above-mentioned components A to C, applying (casting) the fluidized product after vacuum defoaming to a first support, heat treating the supported to give a sheet, adhering a second support after a mold release treatment to the sheet, and winding the sheet into a roll.

Specific examples of the first and second supports include films (sheets) having a single layer made of thermoplastic resin such as polyester (e.g., polybutylene terephthalate (PBT) etc.), ionomer resin wherein ethylene-methacrylic acid copolymer are intermolecularly crosslinked with metal ion (Na⁺, Zn²⁺etc.), EVA (ethylene-vinyl acetate copolymer), PVC (polyvinyl chloride), EEA (ethylene-ethyl acrylate copolymer), PE (polyethylene), PP (polypropylene), polyamide, polybutyral, polystyrene and the like; various thermoplastic elastomers showing rubber elasticity such as polystyrene, polyolefin, polydiene, vinyl chloride, polyurethane, polyester, polyamide, fluororesin, chlorinated polyethylene, polynorbornane, polystyrene-polyolefin copolymer, (hydrogenated) polystyrene-butadiene copolymer, polystyrene-vinylpolyisoprene copolymer and the like; polyolefin such as polyethylene, polypropylene and the like blended with a thermoplastic elastomer and the like, films (sheets) having multiple layers (laminate) made of polyolefin (polypropylene (PP) or polyethylene (PE) etc.)/thermoplastic resin (e.g., EVA)/polyolefin, polyolefin (PP or PE)+thermoplastic elastomer/polyolefin (PP or PE), PP/PE/PP and the like, composite multi-layers (laminate) of polyolefin+thermoplastic elastomer at different blending ratios, etc., and the like. In addition, impregnated paper, coated paper, quality paper, craft paper, cloth, acetate cloth, non-woven fabric, glass cloth and the like can be mentioned.

Examples of the agent for mold release treatment to be used for the first and second supports include silicone mold release treating agent, fluorine mold release treating agent, long chain alkyl mold release treating agent and the like. Of these, a silicone mold release treating agent is preferable. As the curing method, a curing method such as UV irradiation, electron beam irradiation and the like are preferably used. Furthermore, of the silicone mold release treating agents, a cationic polymerizable UV curing silicone mold release treating agent is preferable.

A cationic polymerizable UV curing silicone mold release treating agent is a mixture of a cationic polymerizable silicone (polyorganosiloxane having an epoxy functional group in a molecule) and an onium salt photoinitiator. Such agent wherein the onium salt photoinitiator is a boron photoinitiator is particularly preferable. Using such a cationic polymerizable UV curing silicone mold release treating agent wherein the onium salt photoinitiator is a boron photoinitiator, particularly good release property (mold releasability) can be obtained.

A cationic polymerizable silicone (polyorganosiloxane having an epoxy functional group in a molecule) has at least two epoxy functional groups in one molecule, which may be linear or branched chain, or a mixture of these. While the kind of an epoxy functional group contained in polyorganosiloxane is not particularly limited, it only needs to permit progress of cationic ring-opening polymerization by an onium salt photoinitiator. Specific examples thereof include γ-glycidyloxypropyl group, β-(3,4-epoxycyclohexyl)ethyl group, β-(4-methyl-3,4-epoxycyclohexyl)propyl group and the like. Such cationic polymerizable silicone (polyorganosiloxane having an epoxy functional group in a molecule) is marketed and a commercially available product can be used. For example, UV9315, UV9430, UV9300, TPR6500, TPR6501 and the like manufactured by Toshiba Silicone Co., Ltd., X-62-7622, X-62-7629, X-62-7655, X-62-7660, X-62-7634A and the like manufactured by Shin-Etsu Chemical Co., Ltd., Poly200, Poly201, RCA200, RCA250, RCA251 and the like manufactured by Arakawa Chemical Industries, Ltd. can be mentioned.

Of the cationic polymerizable silicones, polyorganosiloxane comprising the following structural units (A) to (C) is particularly preferable.

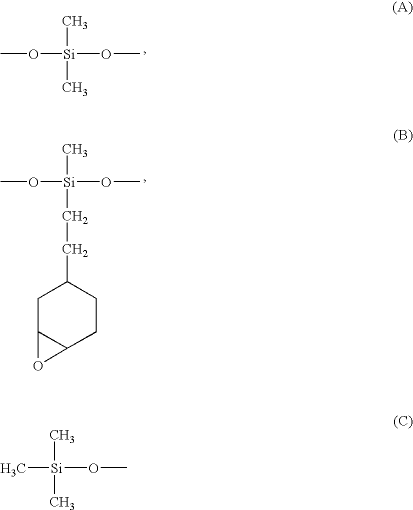

In polyorganosiloxane comprising such structural units (A) to (C), the composition ratio ((A):(B):(C)) of structural units (A) to (C) is particularly preferably 50-95:2-30:1-30 (mol %), and especially preferably 50-90:2-20:2-20 (mol %). Polyorganosiloxane comprising such structural units (A) to (C) is available as Poly200, Poly201, RCA200, X-62-7622, X-62-7629 and X-62-7660.

On the other hand, as the onium salt photoinitiator, a known product can be used without particular limitation. Specific examples include a compound represented by (R¹)₂I⁺X⁻. ArN₂⁺X⁻ or (R¹)₃S⁺X⁻ (wherein R¹ is alkyl group and/or aryl group, Ar is aryl group, X⁻ is [B(C₆H₅)₄]⁻, [B(C₆F₅)₄]⁻, [B(C₆H₄CF₃)₄]⁻, [(C₆F₅)₂BF₂]⁻, [C₆F₅BF₃]⁻, [B(C₆H₃F₂)₄]⁻, BF₄⁻, PF₆⁻, AsF₆⁻, HSO₄⁻, ClO₄⁻ and the like). Of these, a compound of the formula (boron photoinitiator) wherein X⁻ is [B(C₆H₅)₄]⁻, [B(C₆F₅)₄]⁻, [B(C₆H₄CF₃)₄]⁻, [(C₆F₅)₂BF₂]⁻, [C₆F₅BF₃]⁻, [B(C₆H₃F₂)₄]⁻ or BF₄⁻ is preferable, and a compound represented by (R¹)₂I⁺[B(C₆F₅)₄] (wherein R¹ is substituted or unsubstituted phenyl group) (alkyl iodonium, tetrakis(pentafluorophenyl)borate) is particularly preferable. As the onium salt photoinitiator, antimony (Sb) initiator is conventionally known. However, when an antimony (Sb) initiator is used, double detachment occurs and detachment of an impact absorption sheet from a support tends to be difficult.

While the amount of the onium salt photoinitiator to be used is not particularly limited, it is about preferably 0.1-10 parts by weight relative to 100 parts by weight of the cationic polymerizable silicone (polyorganosiloxan). When the amount of use is smaller than 0.1 part by weight, curing of the silicone peel layer may become insufficient. When the amount of use is greater than 10 parts by weight, the cost becomes impractical. When a cationic polymerizable silicone (polyorganosiloxan) and an onium salt photoinitiator are mixed, the onium salt photoinitiator may be dissolved or dispersed in an organic solvent and then mixed with polyorganosiloxan. Specific examples of the organic solvent include alcohol solvents such as isopropyl alcohol, n-butanol and the like; ketone solvents such as acetone, methylethylketone and the like; ester solvents such as ethyl acetate and the like, and the like.

A mold release treating agent can be applied, for example, using a general coating apparatus such as those used for roll coater method, reverse coater method, doctor blade method and the like. While the coating amount (solid content) of the mold release treating agent is not particularly limited, it is generally about 0.05-6 mg/cm².

### EXAMPLES

The present invention is explained in more detail in the following by referring to Examples and Comparative Examples. The properties of the adhesive sheets of Examples and Comparative Examples were evaluated (tested) by the following methods.

### [Shear Storage Elastic Modulus (G′)]

Adhesive sheets having an adhesive layer thickness of 10-250 μm were adhered to each other to give an about 0.5-1 mm laminate. The laminated sheets were punched out into a φ7.9 mm disc and the obtained disc was used as a measurement sample in the measurements by the following methods.

Measurement apparatus: ARES manufactured by Rheometric Scientific

Measurement condition: measurement temperature −30° C. and −50° C.

Measurement frequency 1 Hz (6.28 rad/sec)

### [Haze Value]

An adhesive sheet having an adhesive layer thickness of 200 μm was cut out to give a test sample piece having the size of 50 mm×25 mm. The sample piece was adhered to a glass substrate (S-1111 (trade name) manufactured by Matsunami GLASS Ind., LTD.) to give a measurement test sample. The haze value was measured using a haze meter (HM-150 (product name) manufactured by MURAKAMI COLOR RESEARCH LABORATORY CO., Ltd.), where the sample was set to be on an acceptance surface side of the apparatus, a separator (support) of the test piece was peeled off and the measurement was performed according to JIS K 7136.

### [Measurement of Volatile Organic Material Mass]

The sheet was cut into any size such that the weight of the adhesive (adhesive composition) would be about 0.2 g and the separator was peeled off to give the adhesive alone. The adhesive was placed in a 21.5 ml vial, weighed, and the vial was tightly sealed. Then the vial containing the sample was heated at 140° C. for 30 min in Headspace Sampler (model name 7694, manufactured by Hewlett Packard). The conditions of Headspace Sampler were heating time 12 min, loop filling time 12 min, loop equilibration time 5 min, injection time 3 min, test sample loop temperature 160° C. and transfer line temperature 200° C. Then gas (1.0 ml) in a heating state was injected into a gas chromatogram (model name 6890, manufactured by Hewlett Packard) and the measurement was performed. The conditions of gas chromatogram then were DB-FFAP 1.0 μm (diameter 0.532 mm, length 30 m) column, helium as a carrier gas, carrier gas flow rate 5.0 ml/min, FID as a detector, detector temperature 250° C. From the chart of the obtained gas chromatogram, the amount of the developed gas was converted based on toluene and used as the mass of volatile organic materials (μg) per 1 g of the sample.

### [Re-Peelability Evaluation Test]

### 1. Peeling Distance at Constant Load

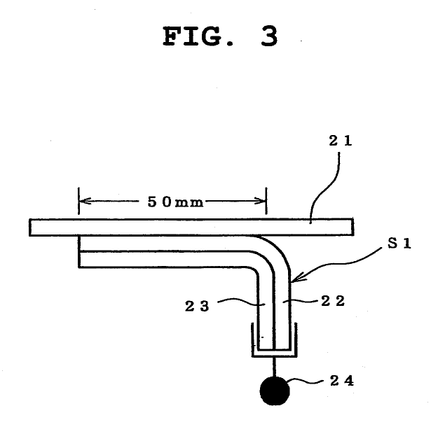

As shown in FIG. 3, an adhesive sheet (test sample piece) S1 (20 mm wide, 70 mm total length) was adhered for a length of 50 mm from one end side to glass 21. A 10 g spindle 24 was attached to the other end, and the time (peeling time) until the adhesive sheet S1 was peeled off from the glass 21 (until the spindle dropped) and the misaligned distance (peeling distance) with time from the start position were measured. In the Figure, symbol 22 is an adhesive layer, and symbol 23 is a separator (support).

The adhesive sheet S1 was adhered to the glass by applying one reciprocation of a 1 kg load roller.

The measurement of the peeling time was started at room temperature immediately after the adhesion.

The misalignment distance was measured at 5 min and 21 hr after the start of the measurement and taken as the peeling distance (mm) with constant load.

2. Re-Peelability Test in Early Stages (Early-Stage Peel Force from Glass, Early-Stage Peel Force from Deflecting Plate)

To one side of an adhesive (adhesive composition) layer was adhered a polyester film (thickness 100 μm) without a mold release treatment, and a test sample piece (width 25 mm, length 100 mm) was cut out. The separator (support) of the sample piece was peeled off, and the piece was press-adhered to a glass plate (PD200 manufactured by ASAHI GLASS CO., LTD.) by one reciprocation of a 2 kg roller, and left standing at room temperature for 24 hr. This was set on a tensile tester and peeled off at a tensile rate of 300 mm/min in a 90° direction. The peeling adhesive force of the test sample piece was measured and used as an early-stage peel force from glass.

In the same manner as above except that a commercially available deflecting plate (SEG1425DUHC manufactured by NITTO DENKO CORPORATION) was adhered to a glass plate (PD200 manufactured by ASAHI GLASS CO., LTD.) such that a hard coat-treated surface would be disposed on the surface side and the laminate was used instead of the glass plate, the peeling adhesive force of the test sample piece was measured and used as an early-stage peel force from deflecting plate.

[Adhesion Reliability Evaluation Test (80° C.-Accelerated Peel Force from Glass, 80° C.-Accelerated Peel Force from Deflecting Plate)]

In the same manner as in the above-mentioned re-peelability test in early stages except that the test sample piece after press-adhesion to a glass plate or a deflecting plate was left standing at 80° C. for 70 hr instead of at room temperature for 24 hr, the peeling adhesive forces of the test sample pieces were measured and used as 80° C.-accelerated peel force from glass and 80° C.-accelerated peel force from deflecting plate.

### [Low Temperature Impact Test]

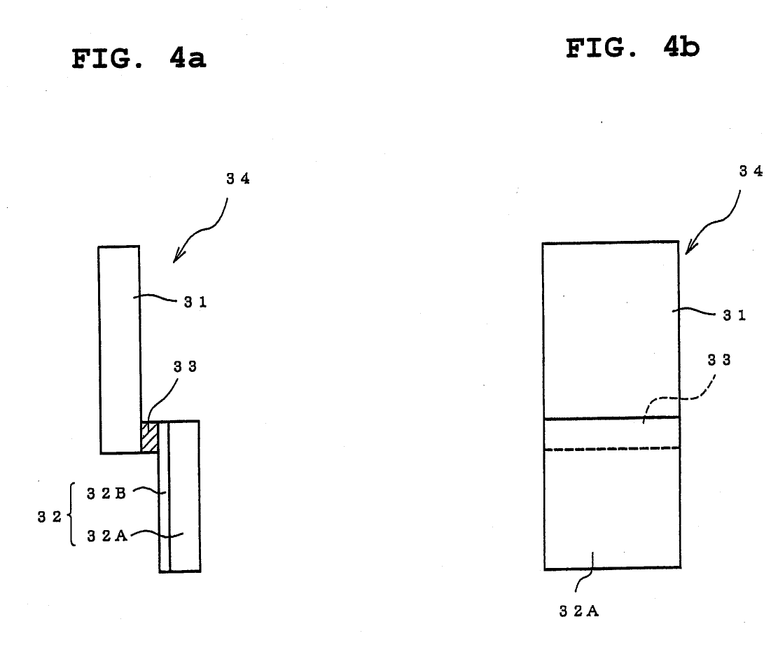

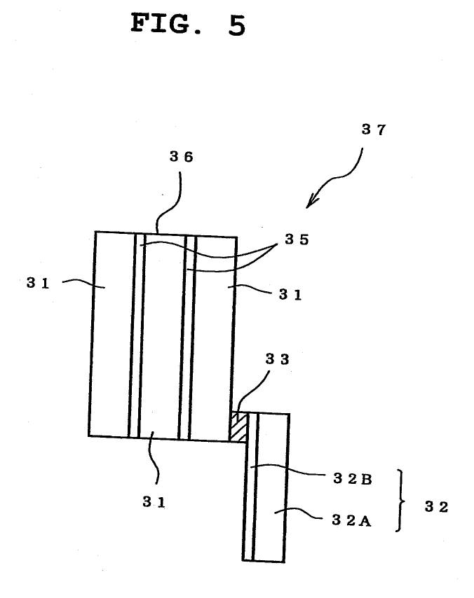

As shown in FIGS. 4 (a) and (b), a glass plate 31 (PD200 manufactured by ASAHI GLASS CO., LTD.) (first width: 50 mm, second width: 120 mm, thickness 2.8 mm), and a laminate 32 wherein a deflecting plate 32B (first width: 50 mm, second width: 70 mm, thickness 2.0 mm) (SEG1425DUHC, manufactured by NITTO DENKO CORPORATION) is laminated on one surface of an acrylic plate 32A (ACRYLITE manufactured by MITSUBISHI RAYON CO., LTD.) having the same size were prepared. Each end part (width 10 mm) in the longitudinal direction was adhered to each other with a 200 μm-thick transparent adhesive sheet (test sample) 33 to give the first test piece 34. Furthermore, one glass plate 31 in the first test sample 34 was changed to a multiple glass plate 36 wherein three glass plates 31 (PD200 manufactured by ASAHI GLASS CO., LTD.) were adhered and integrated using a 125 μm-thick transparent adhesive sheet 35 to give the second test sample 37 (FIG. 5).

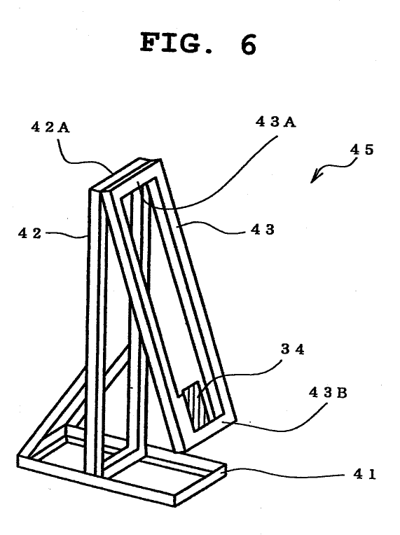

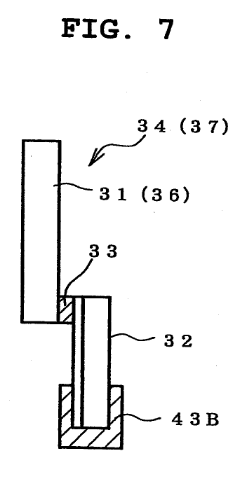

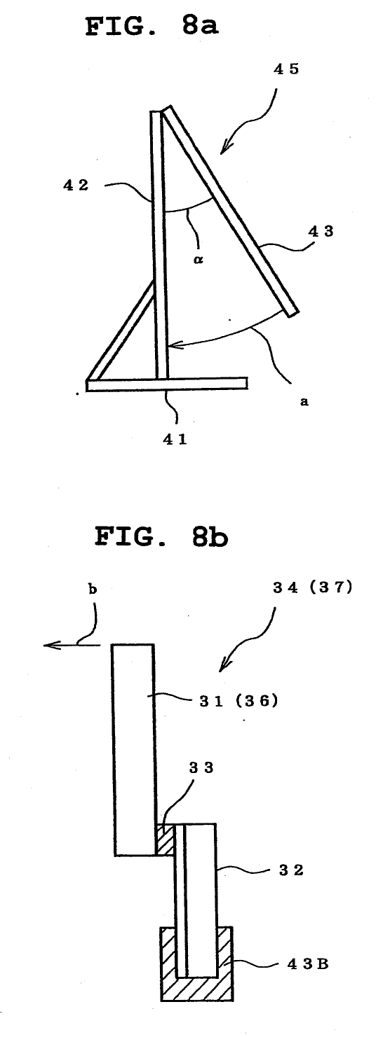

Next, in a first angle 41 of a rectangle frame (long side 610 mm, short side 322 mm) prepared using a stainless plate with a plate thickness of 6 mm and an L-shape section (one side and the other side of L shape are each 50 mm) as shown in FIG. 6 is perpendicularly set a second angle 42 of a rectangle frame (long side 1010 mm, short side 322 mm) prepared using a stainless plate with a plate thickness of 3 mm and an L-shape section (one side and the other side of L shape are each 25 mm). The upper edge frame 42A of said second angle 42 is connected, with a hinge, to the top edge frame 43A of a third angle 43 (total weight 3.3 kg) of a rectangle frame (long side 915 mm, short side 310 mm) prepared using a stainless plate with a plate thickness of 3 mm and an L-shape section (one side and the other side of L shape are each 25 mm) to enable rotation of the third angle 43 about the second angle 42. Using this device, the section of the bottom end frame 43B of the third angle 43 is set to a concave shape to hold the test sample 34 (37) in the test sample holding section (20 mm in length from the bottom end of the laminate plate 32 is held) at −30° C. as shown in FIG. 7. Then, as shown in FIG. 8(a), the third angle 43 is lifted to a position forming a predetermined angle (α) relative to the second angle 42 and released to hit the second angle 42 (moved as arrow a). This operation is done by changing the angle (α).

As shown in FIG. 8(b), due to the above-mentioned hit, a force (fictitious force) is applied to the glass plate 31 (36) in the direction of arrow b in the Figure. The angle at which the glass plate 31 (36) is released, together with the transparent adhesive sheet (test sample) 33, from the laminate plate 32 by this force was measured and taken as the peel off angle.

### [Punching Workability Evaluation]

A 2 mm-thick polystyrene plate was set on any base table, and a sheet (width 10 mm, length 50 mm) was placed thereon. The sheet was constituted with, from the bottom side, a base separator (support), an adhesive and a cover separator (release liner). A Thompson cutter blade (knife angle 43°, mirror finish surface) was pressed against the top of this sheet to cut the sheet. The section of the sheet thus cut was observed with a microscope. Based on the observation results, the incidence (%) of sag (sticking out and sagging of adhesive due to deformation by stress of cutting), and the incidence (%) of delamination (delamination of adhesive from base separator due to stress of cutting) were each calculated from the following formulas (each is average of cutting and observation, n=10).

Sag incidence(%)=(sag length(mm)/sample width(10 mm))×100

Delamination incidence(%)=(delamination length(mm)/sample width(10 mm))×100

Both the sag length and the delamination length were measured using a image processing software (WinROOF manufactured by MITANI CORPORATION).

### [Level Difference Absorbability Test]

A transparent glass electrode substrate was prepared by forming a 3 μm-high line electrode (height: 3 μm, electrode width: 80 μm, line-to-line distance: 450 μm) on one surface of a 2.8 mm-thick transparent glass substrate (PD200 manufactured by ASAHI GLASS CO., LTD.). An adhesive sheet (first width 50 mm×second width 25 mm×thickness 100 μm), from which a cover separator (release liner) had been detached, was pressed on the electrode-formed surface of this transparent glass electrode substrate under the adhesion condition of one reciprocation of a 1 kg roller. This test sample was observed with a microscope from the back side of the transparent glass electrode substrate, and the development of delamination and bubbles beside the electrode due to insufficient absorption of level difference was evaluated according to the following criteria.

◯: no delamination and bubbles

Δ: delamination and/or bubbles only beside the line electrode

x: random delamination and/or bubbles

[Measurement of Change of Resistance of Film with ITO Layer]

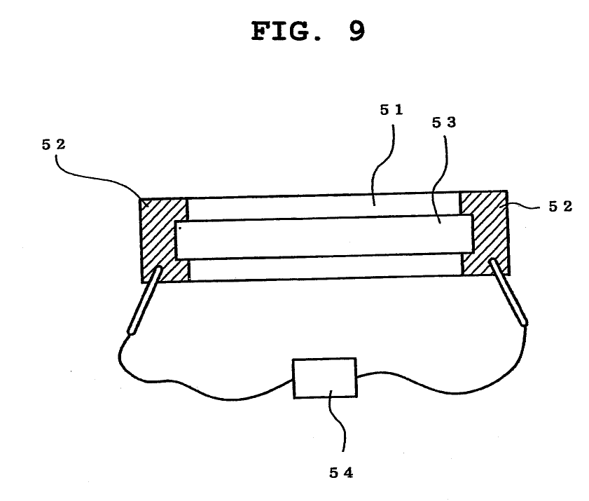

As shown in FIG. 9, a film with an ITO layer formed on the surface (ELECRYSTA (trade name) manufactured by NITTO DENKO CORPORATION) was cut into width 2.5 cm and length 7 cm. A silver paste (DOTITE (trade name) manufactured by FUJIKURA KASEI CO., LTD.) was applied to 1.5 cm from both ends in the length direction of the film 51, and dried by heating to form a silver layer 52. Then, a cover separator (release liner) of the adhesive sheet cut into width 2 cm and length 5 cm was peeled off, and the adhesive sheet (test sample) 53 was adhered to the ITO film 51 having the above-mentioned silver layer 52 with a hand roller to give a test sample. The resistance between the silver layers 52 was measured by a tester 54 and taken as an initial resistance. Thereafter, the test sample was placed in an environment of temperature 60° C. and humidity 90%, and the resistance between the silver layers 52 was measured 45, 72 and 140 hr later. The resistance at that time was divided by the initial resistance to give a resistance change (%). In addition, a test sample without an adhesive tape was simultaneously measured as a blank test sample.

### Example 1

A polyoxyalkylene polymer for component A (number average molecular weight: about 20,000), a hydrosilyl compound for component B in an amount that affords a functional group ratio of 0.75 (its hydrosilyl group amount relative to alkenyl group amount of polyoxyalkylene polymer for component A), and a composition containing a hydrosilylation catalyst (manufactured by KANEKA Corporation, 0.75 mol relative to 1 mol of alkenyl group in component A) for component C were placed in a stirrer with a vacuum apparatus (Mini Dappo manufactured by SEATEC CORPORATION), and the mixture was stirred in vacuo (100 Pa) for 1 hr for defoaming. Then, the vacuum defoamed composition was applied (cast) onto a base separator (support) made of a polyester film (thickness: 100 μm) subjected to a mold release treatment, using a roll coater at room temperature to a composition thickness of 200 μm. The composition was cured by heating in a heating oven at 130° C. for 10 min. A cover separator (release liner) made of a polyester film (thickness: 100 μm) subjected to a mold release treatment in the same manner was adhered to the thus-obtained cured sheet to give a transparent adhesive sheet (measured thickness: 200 μm).

The obtained transparent adhesive sheet showed high transparency (Heze value: 0.5%), and contamination with bubbles was not observed. The shear storage elastic modulus (G′) of the transparent adhesive sheet at −30° C. was 2.5×10⁵ (Pa) and that at −50° C. was 4.3×10⁵ (Pa). Then, the transparent adhesive sheet was evaluated for the mass of volatile organic substance, early stage and 80° C.-accelerated peel force from glass, early stage and 80° C.-accelerated peel force from deflecting plate, peeling distance at constant load, low temperature impact test (adhesion stability at low temperature), and punching processability. The results are shown in Table 1.

### Comparative Example 1

Butyl acrylate (97 parts by weight; hereinafter to be abbreviated as “part”), acrylic acid (3 parts) and azobisisobutyronitrile (0.4 part) were dissolved in ethyl acetate (100 parts), and the mixture was reacted with stirring at about 60° C. to give an acrylic polymer solution. An isocyanate crosslinking agent (3 parts) was added to the obtained solution. The mixture was applied to a 25 μm-thick polyester base separator (support) and dried by heating. A polyester cover separator (release liner) was adhered thereto such that the thickness of the adhesive (applied and dried product) would be 20 μm to give an adhesive sheet having an adhesive thickness of 20 μm. This adhesive sheet having an adhesive thickness of 20 μm was adhered to give an adhesive sheet having an adhesive thickness of 200 μm. The shear storage elastic modulus (G′) of the adhesive sheet was measured. As a result, the shear storage elastic modulus (G′) at −30° C. was 6.2×10⁷ (Pa) and that at −50° C. was 9.7×10⁷ (Pa). Furthermore, the adhesive sheet was evaluated for the mass of volatile organic substance, early stage and 80° C.-accelerated peel forces from glass, early stage and 80° C.-accelerated peel forces from deflecting plate, peeling distance at constant load, low temperature impact test (adhesion stability at low temperature), and punching processability. The results are shown in Table 1.

### Comparative Example 2

In a reaction vessel provided with a cooling tube, a nitrogen inlet tube, a thermometer, a UV irradiation and agitator were placed 2-ethylhexy acrylate (manufactured by TOAGOSEI CO., LTD., 100 parts by weight (hereinafter to be abbreviated as “part”)), 2-hydroxyethyl acrylate (ACRICS HEA (trade name) manufactured by TOAGOSEI CO., LTD., 15 parts), a photopolymerization initiator (IRGACURE 184 (trade name) manufactured by Ciba Specialty Chemicals, 0.15 part), and a photopolymerization initiator (IRGACURE 651 (trade name) manufactured by Ciba Specialty Chemicals, 0.05 part) and they were polymerized by UV irradiation to give a viscose liquid having a polymerization rate of about 10 wt %, which is comprised of a composition containing polymers and monomers. Then, to the viscose liquid were added trimethylolpropane acrylate (V#295 manufactured by OSAKA ORGANIC CHEMICAL INDUSTRY LTD., 0.15 part), a photopolymerization initiator (IRGACURE 184 (trade name) manufactured by Ciba Specialty Chemicals, 0.15 part), and a photopolymerization initiator (IRGACURE 651 (trade name) manufactured by Ciba Specialty Chemicals, 0.05 part) to give a photopolymerization composition. This photopolymerization composition was applied (cast) to a peeling-treated polyester film (thickness 75 μm) such that the thickness of the composition would be 200 μm. The composition was further covered with a polyester film (thickness 50 μm) as a cover, and exposed to UV at 2000 mJ/cm² from a UV lamp to allow photopolymerization to give a UV-cured acrylic adhesive sheet. The obtained adhesive sheet was evaluated for the mass of volatile organic substance, early stage and 80° C.-accelerated peel forces from glass, early stage and 80° C.-accelerated peel forces from deflecting plate, peeling distance at constant load, low temperature impact test (adhesion stability at low temperature), and punching processability. The results are shown in Table 1.

### Comparative Example 3

A blend obtained by mixing and stirring a silicone polymer (SD4592PSA manufactured by Dow Corning Toray Co., Ltd., 100 parts by weight (hereinafter to be abbreviated as “part”) having polydimethyl siloxane as a main skeleton, a crosslinking agent (BY24-741 manufactured by Dow Corning Toray Co., Ltd., 0.6 part) and a curing agent (SRX-212 manufactured by Dow Corning Toray Co., Ltd., 0.54 part) was applied to a 38 μm-thick polyester separator, and dried by heating. A polyester cover separator (release liner) was adhered thereto such that the thickness of the adhesive (applied and dried product) would be 50 μm to give an adhesive sheet having an adhesive thickness of 50 μm. This adhesive sheet having an adhesive thickness of 50 μm was adhered to give an adhesive sheet having an adhesive thickness of 200 μm. The shear storage elastic modulus (G′) of the adhesive sheet was measured. As a result, the shear storage elastic modulus (G′) at −30° C. was 4.3×10⁶ (Pa) and that at −50° C. was 1.4×10⁷ (Pa). The transparent adhesive sheet was evaluated for the mass of volatile organic substance, early-stage peel force from glass, early-stage peel force from deflecting plate, peeling distance at constant load, and low temperature impact test (adhesion stability at low temperature). The results are shown in Table 1.

TABLE 1

| | | | | Comparative | Comparative | Comparative |
|---|---|---|---|---|---|---|
| Evaluated item | | | Example 1 | Example 1 | Example 2 | Example 3 |
| | Thickness of adhesive | [μm] | 200 | 200 | 200 | 200 |
| Transparency | Haze value | [%] | 0.5 | — | — | — |
| Adhesion reliability at | G′ at −30° C. | [Pa] | 2.5 × 10⁵ | 6.2 × 10⁷ | 6.8 × 10⁵ | 4.3 × 10⁶ |
| low temperature | G′ at −50° C. | [Pa] | 4.3 × 10⁵ | 9.7 × 10⁷ | 3.8 × 10⁷ | 1.4 × 10⁷ |
| Low-volatile | Volatile organic material | [μg/g] | 20 | 530 | 93 | 600 |
| substance | mass | | | | | |
| Re-peelability | peeling distance with | [mm] | drop (50 mm) | 0 | 0 | 0 |
| | constant load after 5 min | | | | | |
| | peeling distance with | [mm] | — | 0 | 11 | 0 |
| | constant load after 21 hr | | | | | |
| | early stage re-peeling force | [N/25 mm] | 3.8 | peeling not | 14.3 | 26 |
| | from glass | | | possible (not less | | |
| | | | | than 50) | | |
| | early stage re-peeling force | [N/25 mm] | 1.2 | 26 | 14 | 32.5 |
| | from deflecting plate | | | | | |
| Adhesion reliability | 80° C.-accelerated peel | [N/25 mm] | 17 | peeling not | 22.8 | |
| | force from glass | | | possible (not less | | |
| | | | | than 50) | | |
| | 80° C.-accelerated peel | [N/25 mm] | 18 | peeling not | 14.3 | |
| | force from deflecting plate | | | possible (not less | | |
| | | | | than 50) | | |
| Adhesion reliability | Low temperature impact | Test with 1 sheet of glass | ◯ | X | ◯ | ◯ |
| at low temperature | test | | (No peeling | (Peeled at 60° C.) | (No peeling | (No peeling even |
| | | | even at 90° C.) | | even at 90° C.) | at 90° C.) |
| | | Test with 3 sheets | ◯ | — | X | ◯ |
| | | of glass | (No peeling | | (Peeled at | (No peeling even |
| | | | even at 90° C.) | | 90° C.) | at 90° C.) |
| Punching | Punching processability | sag incidence rate | 0 | 85.6 | 63.8 | |
| processability | | [%] | | | | |
| | | delamination | 0.6 | 12.1 | 90 | |
| | | incidence rate [%] | | | | |

It is clear from Table 1 that the transparent adhesive sheet of the present invention is superior in the re-peelability in the early stages of adhesion, adheres to a glass plate and a deflecting plate (telltale panel) with a high adhesive force as a result of acceleration by heating after adhesion, thus achieving high adhesion reliability to a glass plate and a deflecting plate (telltale panel), and does not become rigid at extremely low temperatures such as below freezing temperature, thus maintaining the high adhesion reliability. In addition, it is clear that the sheet is superior in the punching processability, namely, mass productivity of sheets having a small area, and can be preferably applied to compact displays to be mounted on compact equipments. Furthermore, it is clear that the sheet contains a small mass of organic materials, causes less adverse influence on the human body, and can be particularly preferably applied to displays of mobile equipment.

On the other hand, it is clear that conventional acrylic adhesive sheets and silicone adhesive sheets are difficult to re-adhere when an adhesion failure occurs, since they adhere to glass plates and deflecting plates (telltale panel) with a certain high level of adhesive force from the early stages of adhesion. In addition, they are not suitable for punching processing, and are difficult to apply to compact displays to be mounted on compact equipments. Furthermore, since the mass of volatile organic materials cannot be small, an adverse influence on the human body is feared. Therefore, use thereof for a display of mobile equipments and the like is not very preferable from the aspect of safety.

Moreover, an acrylic adhesive sheet lacks adhesion reliability at extremely low temperatures, and therefore, use thereof for flat-panel displays to be used in cold areas and mountains is not very preferable. Although silicone adhesive sheets afforded good results in low temperature impact tests (−30° C.), the shear storage elastic modulus at −30° C. is greater than that of the adhesive sheet of the present invention, and the difference expanded in the shear storage elastic modulus at −50° C. It is clear therefore that the adhesive sheet of the present invention is difficult to become rigid at extremely low temperatures, and is extremely preferable for use at extremely low temperatures.

### Example 2

In the same manner as in Example 1 except that the coating thickness of the composition was changed to 100 μm, a transparent adhesive sheet was prepared. Using the obtained transparent adhesive sheet, a level difference absorbability test was performed. The results are shown in Table 2.

### Comparative Example 4

In the same manner as in Comparative Example 1 except that the sheets were adhered to a thickness of 100 μm, a transparent adhesive sheet was prepared. Using the obtained sheet, a level difference absorbability test was performed. The results are shown in Table 2.

### Comparative Example 5)

In the same manner as in Comparative Example 3 except that the sheets were adhered to a thickness of 100 μm, a transparent adhesive sheet was prepared. Using the obtained sheet, a level difference absorbability test was performed. The results are shown in Table 2.

TABLE 2

| | | Comparative | Comparative |
|---|---|---|---|
| | Example 2 | Example 4 | Example 5 |
| Thickness of | 100 | 100 | 100 |
| adhesive agent [μm] | | | |
| level difference | ∘ | x | Δ |
| absorbability | | | |

It is clear from Table 2 that the transparent adhesive sheet of the present invention is superior in the level difference absorbability as compared to conventional acrylic or silicone adhesive sheets. Even when, for example, a printed layer is formed on the adhesive surface of a protective transparent plate, thus forming a level difference, the sheet can absorb the difference and prevent delamination of sheet and development of bubbles.

### Example 3

In the same manner as in Example 1 except that the thickness of coating of the composition was changed to 250 μm, a transparent adhesive sheet was prepared. Using the obtained transparent adhesive sheet, the resistance of the film with an ITO layer was measured. The results are shown in Table 3.

### Comparative Example 6

In the same manner as in Comparative Example 1 except that the thickness of an adhesive (applied and dried product) was changed to 25 μm, a sheet was prepared. Using the obtained sheet, the resistance of the film with an ITO layer was measured. The results are shown in Table 3.

### Comparative Example 7

In the same manner as in Comparative Example 2, a sheet with a thickness of 200 μm was prepared. Using the obtained sheet, the resistance of the film with an ITO layer was measured. The results are shown in Table 3.

### Comparative Example 8

In the same manner as in Comparative Example 2 except that isooctyl acrylate (IOAA (trade name) manufactured by OSAKA ORGANIC CHEMICAL INDUSTRY LTD.) was used instead of 2-ethylhexy acrylate in Comparative Example 2 and acrylic acid (manufactured by OSAKA ORGANIC CHEMICAL INDUSTRY LTD., 11 parts by weight) was used instead of 2-hydroxyethyl acrylate (15 parts by weight), a photopolymerized composition was prepared in the same manner as in Comparative Example 2, and a UV cured acrylic adhesive sheet having a thickness of the adhesive of 175 μm was prepared. The shear storage elastic modulus (G′) of the adhesive sheet was measured and, as a result, the shear storage elastic modulus (G′) at −30° C. was 2.5×10⁸ (Pa), and that at −50° C. was 5.7×10⁸ (Pa). This sheet was measured for the resistance of a film with an ITO layer. The results are shown in Table 3.

TABLE 3

| | | | Acceleration time under the environment of | | | | | |
|---|---|---|---|---|---|---|---|---|
| | | Thickness | temperature 60° C. and humidity 90% | | | | | |
| | | of adhesive | (hr) | | | | | |
| | note | [μm] | 0 | 45 | 72 | 137 | 185 | 285 |
| Blank | — | — | 100.0% | 91.7% | 91.8% | 91.8% | 93.3% | 94% |
| Ex. 3 | — | 250 | 100.0% | 93.9% | 93.9% | 94.3% | 94.4% | 95% |
| Com. | Acrylic | 25 | 100.0% | 92.1% | 92.9% | 95.0% | 96.3% | 99% |
| Ex. 6 | solvent | | | | | | | |
| Com. | Acrylic | 200 | 100.0% | 102.3% | 102% | 102% | — | — |
| Ex. 7 | UV curing | | | | | | | |
| | agent | | | | | | | |
| Com. | Acrylic | 175 | 100.0% | 106.3% | 107% | 111% | — | — |
| Ex. 8 | UV curing | | | | | | | |
| | agent | | | | | | | |

It is clear from Table 3 that the transparent adhesive sheet of the present invention (Example 3) shows almost the same resistance change as does the blank, does not corrode the ITO layer with the lapse of time, and can suppress an increase in the resistance of the ITO layer to an extremely low level as compared to conventional acrylic adhesive sheets.

### INDUSTRIAL APPLICABILITY

The present invention contributes to a protection effect and improved visibility by a protective transparent plate of a flat-panel display. In addition, the present invention can be applied to compact flat-panel displays and flat-panel displays with a touch panel, and advantageously acts for the protective effect and improved visibility by a protective transparent plate in compact flat-panel displays and flat-panel displays with a touch panel.

The present application is based on a patent application No. 2007-112194 filed in Japan, the contents of which are incorporated in full herein by this reference.

1. A transparent adhesive sheet for a flat-panel display, which comprises a polyoxyalkylene polymer as a main component and is used for adhesion between a telltale module and a protective transparent plate.

2. The transparent adhesive sheet of claim 1, comprising a cured product of a composition comprising the following components A to C:
A: a polyoxyalkylene polymer having at least one alkenyl group in one molecule
B: a compound comprising two or more hydrosilyl groups on average in one molecule
C: a hydrosilylation catalyst.

3. A transparent adhesive sheet for a flat-panel display, which comprises a polyoxyalkylene polymer as a main component, and is used for interlayer adhesion in a multi-layer structure comprising a telltale module, a protective transparent plate, and at least one functional layer other than the protective transparent plate formed between them.

4. The transparent adhesive sheet of claim 3, comprising a cured product of a composition comprising the following components A to C:
A: a polyoxyalkylene polymer having at least one alkenyl group in one molecule
B: a compound comprising two or more hydrosilyl groups on average in one molecule
C: a hydrosilylation catalyst.

5. The transparent adhesive sheet of claim 3, which is placed in at least one of (a) to (c) in the multi-layer structure:
(a) between the protective transparent plate and the functional layer, (b) between two functional layers, and (c) between the functional layer and the telltale module.

6. The transparent adhesive sheet of claim 5, wherein the functional layer is a constituent member of the touch panel.

7. The transparent adhesive sheet of claim 1, which is obtained by laminating a first support (base separator)/an adhesive sheet/a second support (cover separator) in this order, and processing the laminate into a roll.

8. The transparent adhesive sheet of claim 7, wherein the first and the second supports are detachment-treated with a cationic polymerizable UV cured silicone mold release treating agent comprising a cationic polymerization type silicone and an onium salt photoinitiator.

9. A flat-panel display comprising a telltale module and a protective transparent plate, which are integrated by close adhesion to each other with the transparent adhesive sheet of claim 1 placed between them.

10. A flat-panel display having a multi-layer structure comprising a telltale module, a protective transparent plate, and at least one functional layer other than the protective transparent plate formed between them, and the transparent adhesive sheet of claim 3 placed in at least one interlayer in the multi-layer structure.

11. The flat panel display of claim 10, comprising the transparent adhesive sheet placed in at least one of (a) to (c) in the multi-layer structure: (a) between the protective transparent plate and the functional layer, (b) between two functional layers, and (c) between the functional layer and the telltale module.

12. The flat-panel display of claim 10, wherein the multi-layer structure comprises a touch panel between the telltale module and the protective transparent plate, and the transparent adhesive sheet placed between the telltale module and the touch panel, and/or between the touch panel and the protective transparent plate.

13. A flat-panel display comprising a telltale module and a protective transparent plate, which are integrated by close adhesion to each other with the transparent adhesive sheet of claim 2 placed between them.

14. A flat-panel display having a multi-layer structure comprising a telltale module, a protective transparent plate, and at least one functional layer other than the protective transparent plate formed between them, and the transparent adhesive sheet of claim 4 placed in at least one interlayer in the multi-layer structure.
